(19) United States
(12) Patent Application Publication
(10) Pub. No.: US 2014/0378148 A1
(43) Pub. Date: Dec. 25, 2014

(54) SYSTEMS AND METHODS FOR OPTIMIZING WIRELESS NETWORKS

(71) Applicant: Public Wireless, Inc., San Jose, CA (US)

(72) Inventors: Brett Moser, Atascadero, CA (US); Zhanhe Shi, San Jose, CA (US); Nart Bajj, Canyon Country, CA (US)

(21) Appl. No.: 13/926,829

(22) Filed: Jun. 25, 2013

(51) Int. Cl. H04W 36/00; H04W 36/18

(52) U.S. Cl. CPC H04W 36/0061; H04W 36/18
USPC 455/442

(57) ABSTRACT

A base station operates in a wireless communication network to provide communications coverage for user equipment. The base station maintains a neighbor list of information about other stations. The neighbor list can be autonomously created and updated using information from measurement reports from user equipment, measurement reports from receivers local to the base station, and configuration reports from remote base stations. The base station uses the neighbor list in managing certain operations in a communication network, for example, to determine potential targets for handover of user equipment. The neighbor list can also be used for self-organizing network (SON) operations, such as radio parameter and resource management, and load balancing.

### BACKGROUND

The present invention generally relates to the field of wireless communication systems and to systems and methods for self-organizing network optimization and load balancing.

Growth in wireless communication continues to increase. Demand for data services with high data bandwidth requirements has led to the introduction of multiple modulation techniques for wireless communication, such as Long Term Evolution (LTE), High-Speed Downlink Packet Access+ (HSDPA+), and CDMA2000 1xEV-DO (Evolution-Data Optimized or “EVDO”). Additionally, deployment of small cells including picocells and femtocells has become increasingly desirable for providing coverage. Small cells may be deployed, for example, in areas having high user density, such as airports or event venues. A small cell deployment typically has a 100 meter to 1 kilometer radius. Both voice and data modes are desired in small cell deployments. Development of multi-modal multi-modulation capable small cells is complex. Control of small cells in large networks, for example, for self-organizing networks, is also challenging.

### SUMMARY

A base station, in an embodiment, operates in a wireless communication network to provide communications coverage for user equipment. The base station autonomously maintains a neighbor list of information about other base stations. The neighbor list is created and updated using information from measurement reports from user equipment, measurement reports from receivers local to the base station, and reports from remote base stations. The base station uses the neighbor list in managing certain operations in a communication network, for example, to determine potential targets for handover of user equipment. The neighbor list can also be used for self-organizing network (SON) operations, such as radio parameter and resource management, and load balancing.

In one aspect, the invention provides a method for use in operating a first base station using a neighbor list that includes information about base stations near the first base station, the method comprising: receiving an attachment request from a user equipment; receiving a measurement report from the user equipment, the measurement report including information about transmissions detected by the user equipment, the transmissions being from one or more other base stations; requesting a network address associated with a second base station from a mobility management entity, the second base station being one of the base stations for which information is included in the measurement report; receiving the network address from the mobility management entity; requesting a connection to the second base station using the network address; receiving a connection response from the second base station; and adding the second base station to the neighbor list.

In one aspect, the invention provides a method for use in operating a first base station using a neighbor list that includes information about base stations near the first base station, the method comprising: configuring a radio receiver of the first base station to measure received signals; detecting, using the radio receiver, a transmission broadcast by a second base station; analyzing the detected transmission to create a measurement report; determining, using the measurement report, that the second base station should be added to the neighbor list; requesting a network address associated with the second base station from a mobility management entity; receiving the network address from the mobility management entity; requesting a connection to the second base station using the network address; receiving a connection response from the second base station; and adding the second base station to the neighbor list.

In one aspect, the invention provides a method for use in operating a first base station using a neighbor list that includes information about base stations near the first base station, the method comprising: receiving an attachment request from a user equipment, the attachment request including information about a second base station to which the user equipment is attached; requesting a network address associated with the second base station from a mobility management entity; receiving the network address from the mobility management entity; requesting a connection to the second base station using the network address; receiving a connection response from the second base station; and adding the second base station to the neighbor list.

In one aspect, the invention provides a method for use in operating a first base station, the method comprising: maintaining a neighbor list, the neighbor list including information about base stations near the first base station; and controlling one or more operations of the first base station using the neighbor list.

In another aspect, the invention provides a base station, comprising: one or more radio transceivers, each of the radio transceivers operable to establish wireless communications with user equipments; and a processor arranged for maintaining a neighbor list, the neighbor list including information about base stations near the base station; and controlling one or more operations of the base station using the neighbor list.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a functional block diagram of elements of a wireless communications network in accordance with aspects of the invention;

FIGS. 2-6 are communication sequence graphs showing processes for modifying a neighbor list in accordance with aspects of the invention;

FIG. 7 is a communication sequence graph showing a process for determining radio parameters in accordance with aspects of the invention; and

FIGS. 8-9 are communication sequence graphs showing processes for load balancing in accordance with aspects of the invention.

### DETAILED DESCRIPTION

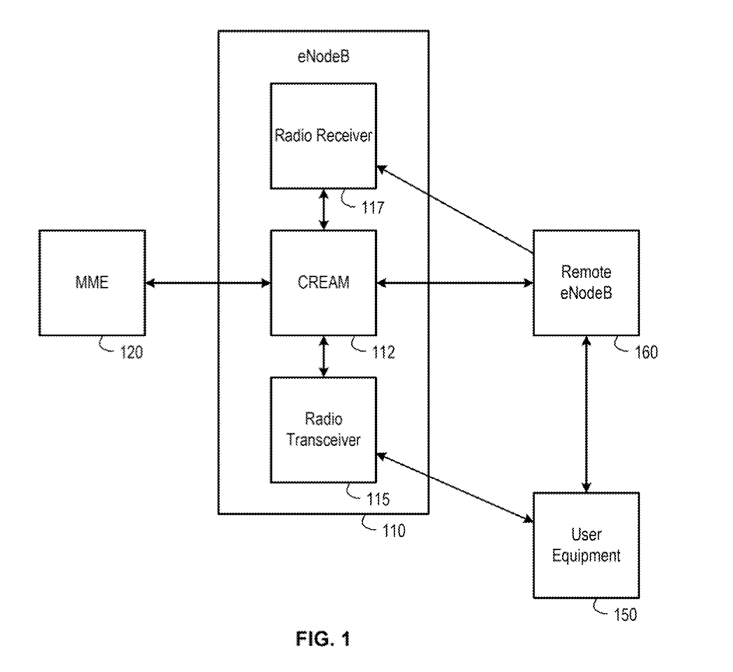

FIG. 1 is a functional block diagram of elements of a wireless communications network in accordance with aspects of the invention. For concise description, various embodiments are described using terminology and organization of particular technologies, standards, and services. However, the systems and methods described herein are broadly applicable to other technologies, standards, and services. Aspects of the wireless communication network of FIG. 1 will be described, for example, using the terminology of long term evolution (LTE) standards.

The wireless communications network includes an evolved Node B (eNodeB or eNB) 110. A node B may also be referred to as a station or base station. The eNodeB 110 may be a small base station that can be deployed to provide coverage for a smaller area than a traditional, or macro, base station. A small base station may also be termed a picocell, femtocell, or small form factor cell. The eNodeB 110 can transmit and receive communications with user equipment. The eNodeB 110 can also communicate with a core network via a backhaul interface.

The eNodeB 110 includes a radio transceiver module 115, a radio receiver module 117, and a common radio element application manager (CREAM) module 112. The radio transceiver module 115 can transmit and receive RF signals to and from user equipment. The radio receiver module 117 is capable of detecting transmissions from transmitters, for example, from other eNodeBs. For example, the radio receiver module 117 may receive broadcast control messages. The radio receiver module 117 may also decode broadcast System Information Blocks in received transmissions. The radio receiver module 117 may be a transceiver that is operating without transmitting.

The CREAM module 112 contains processing capability for use by the eNodeB 110. The CREAM module 112 may perform the various processes described herein. For example, the CREAM module 112 may perform radio resource management, self-configuration, self-optimization, and mobility management of user equipment across multiple radio access technologies. The CREAM module 112 maintains a neighbor list of other stations. The neighbor list can include information about stations, such as the remote transceiver 160, whose transmissions can be detected by the eNodeB 110. The neighbor list may also contain information about more remote stations. Information in the neighbor list may include, for example, capabilities and statuses of the stations. The neighbor list may be stored, for example, in a database.

Local communication paths couple the CREAM module 112 and the radio transceiver module 115 and the radio receiver module 117. Uses of the communication path between the CREAM module 112 and the radio transceiver module 115 include the CREAM module 112 sending commands to user equipment and receiving reports and responses from the user equipment. Uses of the communication path between the CREAM module 112 and the radio receiver module 117 include control of operations of the radio receiver module 117 and transfer of reports of transmissions detected by the radio receiver module 117.

The CREAM module 112, in an embodiment, includes a processor module and a storage module. The processor module can provide the processing capability for the CREAM module 112. The storage module stores data for use by the processor module. The storage module may also store computer readable instructions for execution by the processor module. In addition to executing instructions, the processor module may include specific purpose hardware to accomplish some functions. The instructions can be used by the CREAM module 112 for accomplishing various functions of the eNodeB 110. In an embodiment, the storage module or parts of the storage module may be considered a non-transitory machine readable medium. The hardware of the CREAM module 112 may also be used by other modules of the eNodeB 110.

Although the eNodeB 110 is illustrated in FIG. 1 to include one radio transceiver module, one radio receiver module, and one CREAM module, the eNodeB 110 may include additional modules and may include multiple instances of some modules. For example, the eNodeB may include multiple radio transceiver modules that operate according to different communications standards.

The eNodeB 110 may be configured to provide coverage for one or more mobile phone carriers or network providers. The radio transceiver module 115 (and other radio modules) of the eNodeB 110 may be remotely configured by a network administrator or operator. The radio transceiver modules may be configured to operate using various frequencies (or bands) and communication protocols (or modulation techniques). The radio transceiver modules of the eNodeB 110 may be reconfigured dynamically.

The eNodeB 110 may be arranged to provide communications coverage for multiple cells. Operations and information described as being for a particular eNodeB may be for one of more cells served by that eNodeB.

The wireless communications network also includes a remote transceiver 160. The remote transceiver 160 may be, for example, another eNodeB. The CREAM module 112 can communicate with the remote transceiver 160 via a communications network. Communications between the CREAM module 112 and the remote transceiver 160 may use, for example, an X2 interface. Uses of communications between the eNodeB 110 and the remote transceiver 160 include communication of reports and event notifications regarding status of the remote transceiver 160 and any user equipment connected to the remote transceiver 160. The remote transceiver 160 may perform the same or similar processes as the eNodeB 110. The meaning of local and remote in the disclosed processes can change according to where the processes are implemented.

The wireless communications network also includes a user equipment 150. The user equipment 150 may be, for example, a mobile phone, a tablet computer, or other device that uses voice, data, or other communications services. The user equipment 150 can receive and transmit signals to the eNodeB 110, the remove transceiver 160, or other stations of in communication network. The user equipment 150 can communicate with the radio transceiver 115 of the eNodeB 110 using a wireless communication path. The user equipment 150 can also communicate with the remote transceiver 160 using a wireless communication path. In addition to communicating user data between the user equipment 150 and other devices in or coupled to the wireless communication network, uses of the communication paths between the user equipment 150 and the eNodeB 110 and the remote transceiver 160 include sending control messages to the user equipment 150 and receiving reports and requests from the user equipment 150.

The wireless communications network also includes a mobility management entity (MME) 120. The MME 120 includes a database of network addresses of the LTE transceivers within the wireless communications network. With reference to the eNodeB 110, the database of network addresses may be referred to as a remote database. The MME 120 can operate as a control node that processes signaling between the user equipment and the wireless network. Functions supported by the MME 120 can include bearer management functions (e.g., establishment, maintenance, and release of bearers) and connection management functions (e.g., establishment of connection and security between user equipment and the wireless network).

Although the wireless communications network of FIG. 1 is illustrated to include one eNodeB, one remote transceiver, one MME, and one user equipment, a wireless communications network may include additional devices including multiple instances of some devices. There may also be devices between the devices illustrated in FIG. 1 to be directly coupled. For example, the eNodeB may be coupled to the MME via a gateway device.

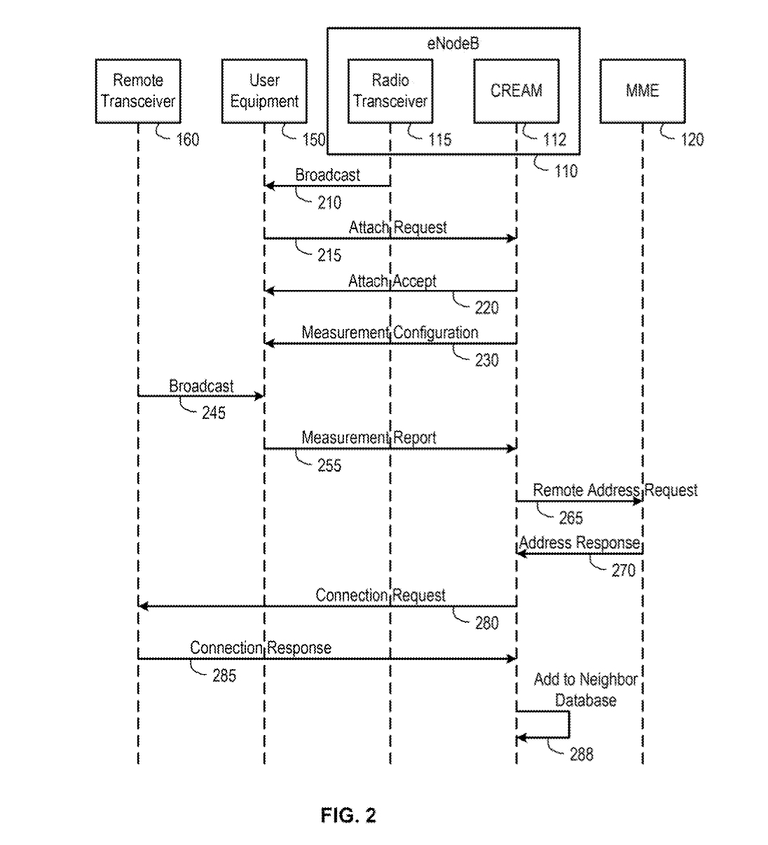

Example embodiments of an eNodeB are described in U.S. application Ser. No. 13/444,704, filed Apr. 11, 2012 and published as U.S. 2010/0264470, which is hereby incorporated by reference. For example, the picocell described with reference to FIG. 2 in U.S. application Ser. No. 13/444,704 may be used to implement the eNodeB 110. Similarly, the wireless communications network may be implemented in the wireless communications network described with reference to FIG. 1 in U.S. application Ser. No. 13/444,704.

FIGS. 2-9 are communication sequence graphs showing processes for use in operating an eNodeB in accordance with aspects of the invention. The processes are described with reference to the wireless communications network of FIG. 1 but may also be used in other communication networks. Additionally, portions of the processes described as being performed by a particular part of a node may also be performed by other parts of the node or be other nodes. The processes may be modified by adding, omitting, reordering, or altering steps. Further, the processes are described in a simple form. An implementation may include additional steps, such as error checking, signaling retries, and acknowledgment time outs.

The processes of FIGS. 2-6 can autonomously modify neighbor lists using multiple sources of information. Example sources of the information include measurement reports from user equipment, measurement reports from receivers located at the eNodeB, and configuration reports from remote transceivers (e.g., received via peer-to-peer communications). Accurate information in the neighbor list can improve network performance. Accordingly, processes that update the neighbor list based on changing information can also improve network performance.

A neighbor list is maintained by a base station, for example, the eNodeB 110 of FIG. 1. The neighbor list can be used in managing certain operations in a communication network, for example, to determine potential targets for handover of user equipment. The neighbor list can also be used for self-organizing network (SON) operations, such as radio resource management, inter-cell interference coordination, and inter-cell management.

FIG. 2 illustrates a process for adding a station to a neighbor list based on information from user equipment. The process may begin when the user equipment 150 detects a transmission 210 from the radio transceiver module 115 of the eNodeB 110. The detected transmission from the eNodeB 110 may be a broadcast of information that identifies the eNodeB 110. The user equipment 150 may detect the transmission, for example, when the user equipment 150 is moved into range of the eNodeB 110 or when the user equipment 150 is powered on.

The user equipment 150 may request attachment 215 to the eNodeB 110. In the illustrated process, the eNodeB 110 accepts attachment 220 by the user equipment 150. The CREAM module 112 in the eNodeB 110 can receive the attachment request and accept the attachment.

After attaching the user equipment 150, the CREAM module 112 of the eNodeB 110 commands 230 the user equipment 150 to supply measurement reports. The measurement reports include information about signal received from other eNodeBs (e.g., the remote transceiver 160). The measurement reports include identification of the eNodeBs and an indication of signal strength or quality. The command 230 from the eNodeB 110 may be for information about transmissions detected with greater than a minimum signal strength. The minimum signal strength may be specified in the command or may be predetermined.

To supply the measurement reports, the user equipment 150 detects transmissions broadcast 245 from the other eNodeBs, such as the remote transceiver 160. The user equipment 150 analyzes to the received transmissions to determine information for the measurement reports. For example, the user equipment 150 may measure reference signal received power. The user equipment 150 supplies the measurement reports 255 to the CREAM module 112 in the eNodeB 110.

The eNodeB 110 sends requests 265 to the MME 120 for the network address of the remote transceiver 160 (and other eNodeBs for which measurement reports were received). The network addresses may be, for example, the IP address of the eNodeBs. The MME 120 responds 270 by supplying the requested network addresses to the eNodeB 110.

Using the network addresses, the CREAM module 112 in the eNodeB 110 requests a connection 280 with the remote transceiver 160 (and other eNodeBs for which measurement reports and network addresses were received). The remote transceiver 160 (and other eNodeBs) accepts the connection request 285. The CREAM module 112 in the eNodeB 110 then adds 288 the remote transceiver 160 (and other eNodeBs) to its neighbor list. The added eNodeBs may then be considered for use, for example, in subsequent handovers of user equipments.

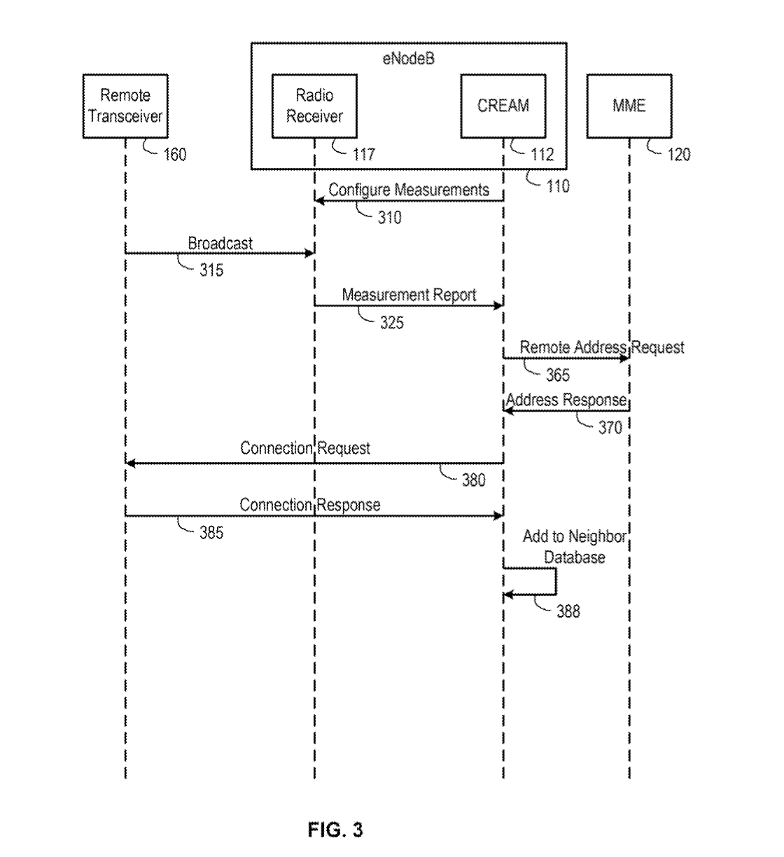

FIG. 3 illustrates a process for adding a station to a neighbor list based on information about transmissions detected locally at the eNodeB maintaining the neighbor list. The process may begin by the CREAM module 112 in the eNodeB 110 configuring 310 the radio receiver module 117 to measure received signals. The radio receiver module 117 may be configured to detect certain signals of certain types, frequencies, and other criteria. When the radio receiver module 117 detects transmissions broadcast 315 from the other eNodeBs, such as the remote transceiver 160, the radio receiver module 117 analyzes the received transmissions to determine information for measurement reports. For example, the radio receiver module 117 may measure reference signal received power. Information in the measurement report may contain, for example, signal power measurements or signal quality measurements. The radio receiver module 117 supplies the measurement reports 325 to the CREAM module 112 in the eNodeB 110.

The CREAM module 112, based on the measurement reports, can determine whether another eNodeB is a suitable candidate to be used as a neighbor. The determination can be based, for example, on signal strength. For eNodeBs that are neighbor candidates, the eNodeB 110 sends requests 365 to the MME 120 for the network address of the remote transceiver 160 (and other eNodeBs). The MME 120 responds by supplying the requested network addresses 370 to the eNodeB 110. The CREAM module 112 in the eNodeB 110 requests a connection 380 with the remote transceiver 160 (and other eNodeBs). The remote transceiver 160 (and other eNodeBs) accepts the connection request 385. The CREAM module 112 in the eNodeB 110 then adds the remote transceiver 160 (and other eNodeBs) to its neighbor list 388. The added eNodeBs may then be considered for use. In various embodiments, the process steps for acquiring addresses, establishing connections, and adding to the neighbor list are the same or similar to those in the process of FIG. 2.

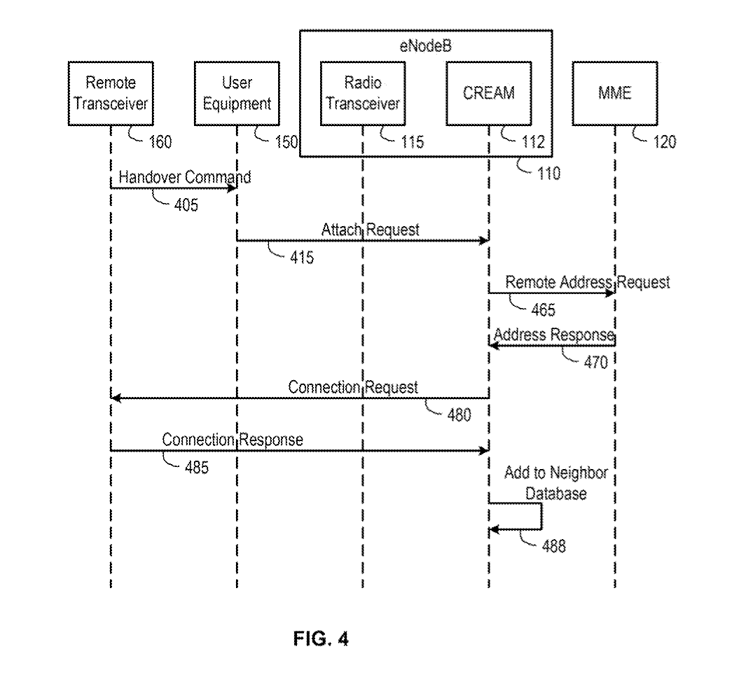

FIG. 4 illustrates a process for adding a station to a neighbor list based on information related to handover or a user equipment. The process may begin when the user equipment 150 receives a handover command 405 from the remote transceiver 160 (at the beginning of the illustrated example of the process, the user equipment 150 is connected to the remote transceiver 160). The user equipment 150 then requests attachment 415 to the eNodeB 110. The attach request includes identification of the remote transceiver 160. The attach request may include further information about the remote transceiver 160.

The CREAM module 112 can determine whether the remote transceiver 160 is a suitable candidate to be used as a neighbor. The determination can be based, for example, on shared abilities or shared coverage. If the remote transceiver 160 is neighbor candidate, the eNodeB 110 sends a request 465 to the MME 120 for the network address of the remote transceiver 160. The MME 120 responds by supplying the requested network addresses 470 to the eNodeB 110. The CREAM module 112 in the eNodeB 110 requests a connection 480 with the remote transceiver 160. The remote transceiver 160 accepts the connection request 485. The CREAM module 112 in the eNodeB 110 then adds the remote transceiver 160 to its neighbor list 488. The added remote transceiver may then be considered for use. In various embodiments, the process steps for acquiring addresses, establishing connections, and adding to the neighbor list are the same or similar to those in the processes of FIGS. 2 and 3.

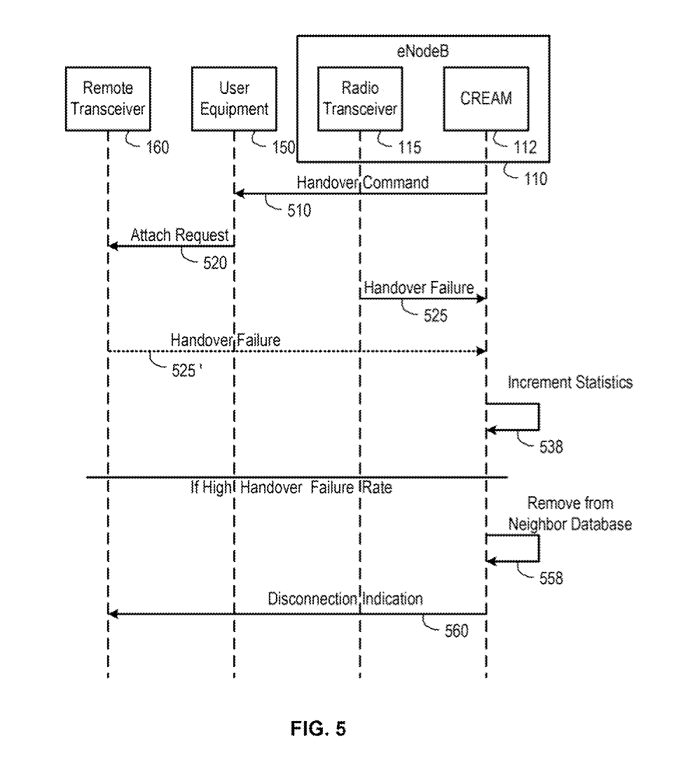

FIG. 5 illustrates a process for deleting a station from a neighbor list based on information user equipment handover failures. The process may begin when the CREAM module 112 of the eNodeB 110 sends a handover command 510 to the user equipment 150 signaling it to perform handover to the remote transceiver 160. The user equipment 150 requests attachment 520 to the remote transceiver 160. If handover of the user equipment 150 to the remote transceiver 160 succeeds, the remainder of the process is not performed. However, the handover may fail.

The CREAM module 112 of the eNodeB may receive notification of handover failure. The notification may be detected, for example, by the radio transceiver module 115 of the eNodeB 110 or by the remote transceiver 160. When radio transceiver module 115 detects handover failure, the radio transceiver module 115 signals the failure 525 to the CREAM module 112. Similarly, when the remote transceiver 160 detects handover failure, the remote transceiver 160 signals the failure 525′ to the CREAM module 112.

The CREAM module 112 maintains statistical information about handover failures. The statistics are for particular handover targets. When the CREAM module 112 receives 525, 525′ the indication of handover failure, it updates 538 the statistical information. Example handover failure statistics include a count of failures, a ratio of handover failures to handover attempts, and an average time between handover failures.

The CREAM module 112 can analyze the statistical information to detect that handovers to the remote transceiver 160 have a high failure rate. The detection of a high failure rate may vary with the statistics used. For example, CREAM module 112 may detect a high failure rate when more than half of the attempted handovers fail. The detection may also be dynamic, for example, based on other available neighbors. When CREAM module 112 detects a high failure rate, the remote transceiver 160 is removed from the neighbor list 558. The CREAM module 112 then disconnects communication 560 with the remote transceiver 160.

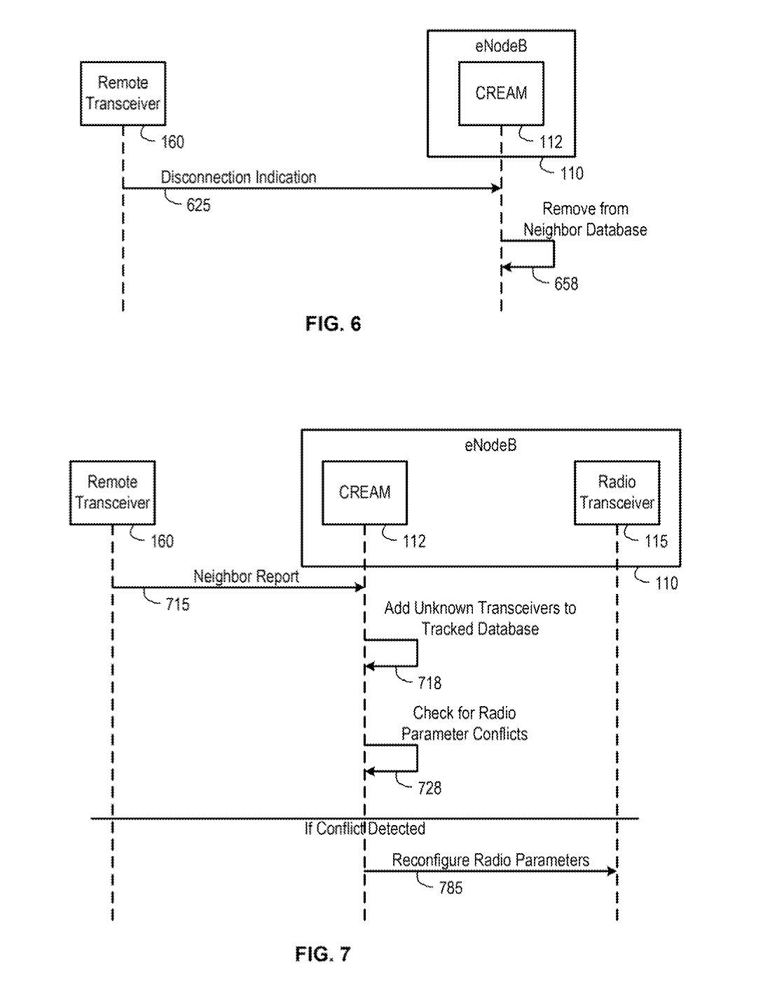

FIG. 6 illustrates a process for deleting a station from a neighbor list based on information about or actions by another eNodeB. The process may begin when the CREAM module 112 of the eNodeB 110 receives 625 an indication that the remote transceiver 160 should be removed from the neighbor list. For example, the eNodeB 110 may detect that the remote transceiver 160 has disconnected network communications with the CREAM module 112. When CREAM module 112 determines that the remote transceiver 160 should be removed from the neighbor list, the remote transceiver 160 is removed 658 from the neighbor list.

FIG. 7 is a communication sequence graph showing a process for determining radio parameters in accordance with aspects of the invention. The process can determine radio parameters autonomously, for example, without control by a network operator. The process, in an embodiment, works to determine maximally-unique radio parameters from multiple sources of information. The process can analyze various sources of information to determine the radio parameters. Example sources of information include measurement reports from user equipments, measurement reports from receivers located with the eNodeB, and configuration reports from other eNodeBs.

The process can also be used to add neighbors of neighbors to a neighbor list. For example, after a new neighbor cell is added to a neighbor list using one of the processes of FIG. 2, 3, or 4, the process of FIG. 7 can be used to add neighbors of the new neighbor cell to the neighbor list.

The process may begin when the CREAM module 112 of the eNodeB 110 receives a report 715 from the remote transceiver 160 about neighbors of the remote transceiver 160. The report includes information about eNodeBs that are in the neighbor list of the remote transceiver 160. The remote transceiver 160 may send the neighbor report, for example, after a communication connection (e.g., as in steps 280, 285 of the process of FIG. 2) is made between the eNodeB 110 and the remote transceiver 160. The neighbor report may also be requested by the eNodeB 110.

The CREAM module 112 of the eNodeB 110 analyzes the received neighbor report to detect whether it includes information about stations that are not in the neighbor list. Any new stations that are not in the neighbor list are added to the neighbor list 718.

After new stations are added to the neighbor list, the CREAM module 112 of the eNodeB 110 analyzes the updated neighbor list to check for radio parameter conflicts 728. If a conflict is detected, the CREAM module 112 can reconfigure 785 the radio transceiver module 115 with new radio parameters to resolve the conflict.

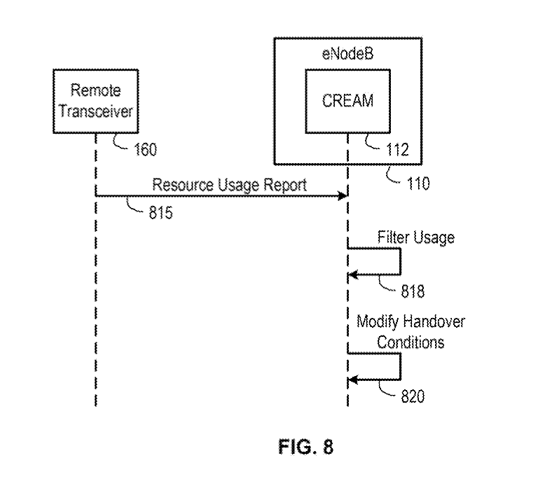

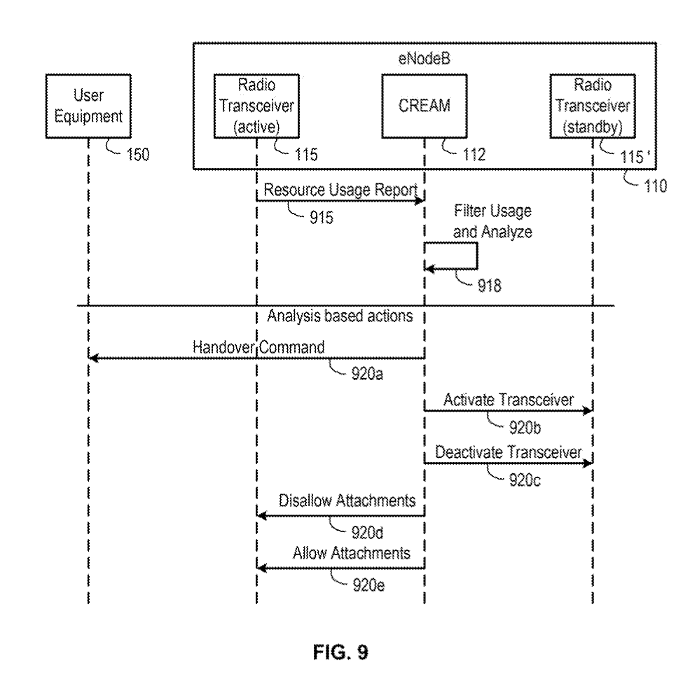

FIGS. 8-9 are communication sequence graphs showing processes for load balancing in accordance with aspects of the invention. The processes can perform load balancing in a wireless communication network autonomously, for example, without control by a network operator. Load balancing can improve communication network performance by distributing demands for communication over available resources. The process can be used by an eNodeB to analyze various sources of information to determine the load balancing. Example sources of information include resource usage measurements made locally at the eNodeB and resource usage measurements received from other eNodeBs. The processes can combine information from multiple sources to determine load balancing actions. The resource usage measurements may be on all available radio access technologies.

FIG. 8 illustrates a process for use in load balancing when the eNodeB receives a resource usage report from another eNodeB. The process may begin when the CREAM module 112 of the eNodeB 110 receives a report 815 from the remote transceiver 160 about resource usage. The remote transceiver 160 may send the report, for example, after a communication connection (e.g., as in steps 280, 285 of the process of FIG. 2) is made to the eNodeB 110, in response to a request by to the eNodeB 110, or based on changes in resource usage.

The CREAM module 112 filters 818 the received resource usage information. The filtering may time average the information. The CREAM module 112 uses the filtered resource usage information to determine one or more load balancing actions 820. In an embodiment, conditions for handover of user equipment are modified. For example, if the resource usage information indicates that a particular cell has low utilization, the conditions for handover can be modified to increase handovers to that particular cell.

FIG. 9 illustrates a process for use in load balancing using local resource usage reports. The process may begin when the CREAM module 112 of the eNodeB 110 receives a report 915 from radio transceiver module 115 about resource usage. The radio transceiver module 115 may send the resource usage report, for example, in response to a request from the CREAM module 112, periodically, or based on usage status.

The CREAM module 112 filters and analyzes 918 the received resource usage information. The CREAM module 112 uses the resource usage information to determine one or more load balancing actions 920. One load balancing action that may be taken includes the CREAM module 112 sending a handover command 920a to the user equipment 150 that is attached to the eNodeB to handover to a different cell. This type of load balancing action may be taken, for example, when the analysis of the resource usage indicates that the resources are highly used at the eNodeB 110.

Another load balancing action that may be taken includes the CREAM module 112 activating 920b a standby radio transceiver 115′. The standby radio transceiver 115′ is a radio transceiver in the eNodeB 110 that was not being used for communication with user equipment. Activating the standby radio transceiver 115′ transitions it to a state for use in communications with user equipment. Another load balancing action that may be taken includes the CREAM module 112 deactivating 920c the previously activated standby radio transceiver 115′. Activating a standby radio receiver for load balancing may be performed, for example, when the analysis of the resource usage indicates that the resources are highly used at the eNodeB 110. Conversely, deactivating a standby radio receiver for load balancing may be performed, for example, when the analysis of the resource usage indicates that the resources are lightly used at the eNodeB 110.

Another load balancing action that may be taken includes the CREAM module 112 signaling 920d the radio transceiver 115 that attachments of new user equipment to the radio transceiver 115 may be disallowed. Another load balancing action that may be taken includes the CREAM module 112 signaling 920e the radio transceiver 115 that attachments of new user equipments to the radio transceiver 115 can now be allowed. The various load balancing actions 920 can also be performed by the process of FIG. 8.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art.

What is claimed is:

1. A method for use in operating a first base station using a neighbor list that includes information about base stations near the first base station, the method comprising:
receiving an attachment request from a user equipment;
receiving a measurement report from the user equipment, the measurement report including information about transmissions detected by the user equipment, the transmissions being from one or more other base stations;
requesting a network address associated with a second base station from a mobility management entity, the second base station being one of the base stations for which information is included in the measurement report;
receiving the network address from the mobility management entity;
requesting a connection to the second base station using the network address;
receiving a connection response from the second base station; and
adding the second base station to the neighbor list.

2. The method of claim 1, further comprising transmitting a measurement request to the user equipment, and wherein the user equipment transmits the measurement report after receiving the measurement request from the first base station.

3. The method of claim 1, further comprising:
receiving a report from the second base station, the report containing information about base stations that are neighbors of the second base station;
analyzing the received report to detect whether it includes information about a new base station that is not in the neighbor list; and
adding the new base station to the neighbor list.

4. The method of claim 1, further comprising:
detecting that the second base station has disconnected communication with the first base station; and
removing the second base station from the neighbor list.

5. The method of claim 1, further comprising:
transmitting a handover command to a user equipment signaling the user equipment to handover to the second base station;
detecting that handover of the user equipment to the second base station failed;
updating statistical information about handovers based on the handover failure;
analyzing the statistical information to determine that the second base station should be removed from the neighbor list; and
removing the second base station from the neighbor list.

6. The method of claim 5, further comprising disconnecting a communication with the second base station after determining that the second base station should be removed from the neighbor list.

7. The method of claim 5, wherein detecting handover failure comprises receiving an indication of failure from the second base station.

8. The method of claim 5, wherein detecting handover failure comprises detecting that the user equipment continues to communicate with the first base station.

9. The method of claim 1, further comprising analyzing the neighbor list after adding the new base station to detect a radio parameter conflict.

10. The method of claim 9, further comprising modifying one or more radio parameters used by the first base station to resolve the radio parameter conflict.

11. A method for use in operating a first base station using a neighbor list that includes information about base stations near the first base station, the method comprising:
configuring a radio receiver of the first base station to measure received signals;
detecting, using the radio receiver, a transmission broadcast by a second base station;
analyzing the detected transmission to create a measurement report;
determining, using the measurement report, that the second base station should be added to the neighbor list;
requesting a network address associated with the second base station from a mobility management entity;
receiving the network address from the mobility management entity;
requesting a connection to the second base station using the network address;
receiving a connection response from the second base station; and
adding the second base station to the neighbor list.

12. The method of claim 11, wherein the measurement report includes information about a signal strength received by the radio receiver.

13. The method of claim 11, further comprising:
receiving a report from the second base station, the report containing information about base stations that are neighbors of the second base station;
analyzing the received report to detect whether it includes information about a new base station that is not in the neighbor list; and
adding the new base station to the neighbor list.

14. The method of claim 11, further comprising:
detecting that the second base station has disconnected communication with the first base station; and
removing the second base station from the neighbor list.

15. The method of claim 11, further comprising:
transmitting a handover command to a user equipment signaling the user equipment to handover to the second base station;
detecting that handover of the user equipment to the second base station failed;
updating statistical information about handovers based on the handover failure;
analyzing the statistical information to determine that the second base station should be removed from the neighbor list; and
removing the second base station from the neighbor list.

16. A method for use in operating a first base station using a neighbor list that includes information about base stations near the first base station, the method comprising:
receiving an attachment request from a user equipment, the attachment request including information about a second base station to which the user equipment is attached;
requesting a network address associated with the second base station from a mobility management entity;
receiving the network address from the mobility management entity;
requesting a connection to the second base station using the network address;
receiving a connection response from the second base station; and
adding the second base station to the neighbor list.

17. The method of claim 16, wherein the attachment request is sent from the user equipment in response to a handover command received by the user equipment from the second base station.

18. The method of claim 16, further comprising:
receiving a report from the second base station, the report containing information about base stations that are neighbors of the second base station;
analyzing the received report to detect whether it includes information about a new base station that is not in the neighbor list; and
adding the new base station to the neighbor list.

19. The method of claim 16, further comprising:
detecting that the second base station has disconnected communication with the first base station; and
removing the second base station from the neighbor list.

20. The method of claim 16, further comprising:
transmitting a handover command to a user equipment signaling the user equipment to handover to the second base station;
detecting that handover of the user equipment to the second base station failed;
updating statistical information about handovers based on the handover failure;
analyzing the statistical information to determine that the second base station should be removed from the neighbor list; and
removing the second base station from the neighbor list.

21. A method for use in operating a first base station, the method comprising:
maintaining a neighbor list, the neighbor list including information about base stations near the first base station; and
controlling one or more operations of the first base station using the neighbor list.

22. The method of claim 21, further comprising using the list of neighbor cells to determine a handover decision.

23. The method of claim 21, wherein maintaining the neighbor list comprises updating the neighbor list based on information received from user equipment about transmissions received from other base stations.

24. The method of claim 23, wherein maintaining the neighbor list further comprises updating the neighbor list based on information about transmissions received from other base stations by the first base station.

25. The method of claim 24, wherein maintaining the neighbor list further comprises updating the neighbor list based on information received other base stations about neighbor lists of the other base stations.

26. The method of claim 21, controlling one or more operations of the first base station using the neighbor list comprises:
receiving a report from a second base station, the second base station being one of the base stations for which information is included in the neighbor list, the report containing information about resource usage of the second base station; and
analyzing the received report to determine a load balancing action.

27. The method of claim 26, wherein controlling one or more operations of the first base station using the neighbor list further comprises transmitting a request for resource usage information to the second base station, and wherein the second base station transmits the report after receiving the request from the first base station.

28. The method of claim 26, wherein the load balancing action comprises modifying conditions for handover of a user equipment to the second base station.

29. The method of claim 21, further comprising analyzing information about resource usage of the first base station to determine a load balancing action.

30. The method of claim 29, wherein the information about resource usage comprises information from a radio transceiver module of the base station.

31. The method of claim 29, wherein the load balancing action comprises commanding a user equipment connected to the first base station to handover to a second base station, the second base station selected using the neighbor list.

32. The method of claim 29, wherein the load balancing action comprises activating a radio transceiver module of the first base station that was in a standby mode.

33. The method of claim 29, wherein the load balancing action comprises deactivating a radio transceiver module of the first base station to a standby mode.

34. The method of claim 29, wherein the load balancing action comprises disallowing additional user equipment to attach to the first base station.

35. The method of claim 29, wherein the load balancing action comprises re-allowing additional user equipment to attach to the first base station.

36. A base station, comprising:
one or more radio transceivers, each of the radio transceivers operable to establish wireless communications with user equipments; and
a processor arranged for
maintaining a neighbor list, the neighbor list including information about other base stations near the base station; and
controlling one or more operations of the base station using the neighbor list.

37. The base station of claim 36, wherein the processor is further arranged for using the list of neighbor cells to determine a handover decision.

38. The base station of claim 36, wherein maintaining the neighbor list comprises updating the neighbor list based on information received from a user equipment about transmissions received from other base stations.

39. The base station of claim 38, wherein maintaining the neighbor list further comprises updating the neighbor list based on information about transmissions received from other base stations by the base station.

40. The base station of claim 39, wherein maintaining the neighbor list further comprises updating the neighbor list based on information received other base stations about neighbor lists of the other base stations.

41. The base station of claim 36, wherein maintaining the neighbor list comprises:
receiving an attachment request from a user equipment;
receiving a measurement report from the user equipment, the measurement report including information about transmissions detected by the user equipment, the transmissions being from one or more other base stations;
requesting a network address associated with a second base station from a mobility management entity, the second base station being one of the base stations for which information is included in the measurement report;
receiving the network address from the mobility management entity;
requesting a connection to the second base station using the network address;
receiving a connection response from the second base station; and
adding the second base station to the neighbor list.

42. The base station of claim 36, further comprising a radio receiver, and wherein maintaining the neighbor list comprises:
configuring the radio receiver to detect a transmission broadcast by a second base station;
analyzing the detected transmission to create a measurement report;
determining, using the measurement report, that the second base station should be added to the neighbor list;
requesting a network address associated with the second base station from a mobility management entity;
receiving the network address from the mobility management entity;
requesting a connection to the second base station using the network address;
receiving a connection response from the second base station; and
adding the second base station to the neighbor list.

43. The base station of claim 36, wherein maintaining the neighbor list comprises:
receiving an attachment request from a user equipment, the attachment request including information about a second base station to which the user equipment is attached;
requesting a network address associated with the second base station from a mobility management entity;
receiving the network address from the mobility management entity;
requesting a connection to the second base station using the network address;
receiving a connection response from the second base station; and
adding the second base station to the neighbor list.

44. The base station of claim 36, wherein maintaining the neighbor list comprises:
transmitting a handover command to a user equipment signaling the user equipment to handover to a second base station, the second base station being one the base stations for which information is in the neighbor list;
detecting that handover of the user equipment to the second base station failed;
updating statistical information about handovers based on the handover failure;
analyzing the statistical information to determine that the second base station should be removed from the neighbor list; and
removing the second base station from the neighbor list.

45. The base station of claim 36, wherein maintaining the neighbor list comprises:
detecting that a second base station has disconnected communication with the base station; and
removing the second base station from the neighbor list.

46. The base station of claim 36, wherein maintaining the neighbor list comprises:
receiving a report from a second base station, the second base station being one the base stations for which information is in the neighbor list, the report containing information about base stations that are neighbors of the second base station;
analyzing the received report to detect whether it includes information about a new base station that is not in the neighbor list; and
adding the new base station to the neighbor list.

47. The base station of claim 46, wherein maintaining the neighbor list further comprises analyzing the neighbor list after adding the new base station to detect a radio parameter conflict, and modifying one or more radio parameters used by the radio transceivers to resolve the radio parameter conflict.

48. The base station of claim 36, wherein controlling one or more operations of the base station using the neighbor list comprises:
receiving a report from a second base station, the second base station being one of the base stations for which information is included in the neighbor list, the report containing information about resource usage of the second base station; and
analyzing the received report to determine a load balancing action.

49. The base station of claim 36, wherein the processor is further arranged for analyzing information about resource usage of the base station to determine a load balancing action.

50. The base station of claim 49, wherein the load balancing includes an action selected from the group consisting of:
commanding a user equipment connected to the base station to handover to a second base station, the second base station selected using the neighbor list;
activating one of the radio transceivers that was in a standby mode;
deactivating one of the radio transceivers to a standby mode;
disallowing additional user equipment to attach to the base station; and
re-allowing additional user equipment to attach to the base station.
